(19) United States
(12) Patent Application Publication
(10) Pub. No.: US 2014/0063592 A1
(43) Pub. Date: Mar. 6, 2014

(54) 6x28-Gbaud Few-Mode Fiber Recirculating Loop Transmission with Gain-Equalized Inline Few-Mode Fiber Amplifier

(71) Applicant: NEC LABORATORIES AMERICA, INC., Princeton, NJ (US)

(72) Inventor: Ezra Ip, Plainsboro, NJ (US)

(73) Assignee: NEC LABORATORIES AMERICA, INC., Princeton, NJ (US)

(21) Appl. No.: 14/019,015

(22) Filed: Sep. 5, 2013

Related U.S. Application Data
(60) Provisional application No. 61/697,123, filed on Sep. 5, 2012.

(51) Int. Cl. H01S 3/13

(52) U.S. Cl. CPC H01S 3/1302
USPC 359/337.1

(57) ABSTRACT

Disclosed herein are methods, structures and systems for few-mode fiber (FMF) transmission including an optical amplifier exhibiting modal gain control suitable for such transmission in which higher order modes are amplified. An exemplary evaluation system is described and results presented.

### CROSS REFERENCE TO RELATED APPLICATIONS

This application claims the benefit of U.S. Provisional Patent Application Ser. No. 61/697,123 filed Sep. 5, 2012 which is incorporated by reference in its entirety as if set forth at length herein.

### TECHNICAL FIELD

This disclosure relates generally to the field of optical communications and in particular to a methods, apparatus and structures pertaining to optical transmission using gain-equalized inline few-mode fiber amplifiers while being described using an exemplary 6×28 few-mode fiber recirculating loop transmission arrangement.

### BACKGROUND

Contemporary optical communications systems make extensive use of single mode optical fiber whose capacity limits are rapidly approaching. Consequently, methods, apparatus and structures that prolong the growth in capacity of such systems would represent a welcome addition to the art.

### SUMMARY

An advance in the art is made according to an aspect of the present disclosure directed to methods, structures and systems for few-mode fiber (FMF) transmission. In particular, an optical amplifier exhibiting modal gain control suitable for such transmission in which higher order modes are amplified is described along with an exemplary implementation.

Viewed from a first aspect, the present disclosure is directed to a few-mode amplifier that simultaneously amplifies multiple signal modes of an optical signal within a single device that includes a mechanism for controlling the modal gain of various signal modes. Advantageously, the device may be used for few-mode fiber transmission over multi-span distances. In sharp contrast to alternative, prior-art devices, a device according to the present disclosure circumvents the need to perform mode (de)multiplexing after every span in order to amplify different modes using conventional single-mode amplifiers.

A representative structure according to the present disclosure includes: a optically coupling the optical fibers to a coupler integrated within the PIC.

### BRIEF DESCRIPTION OF THE DRAWING

A more complete understanding of the present disclosure may be realized by reference to the accompanying drawings in which:

FIG. 1(a) shows a schematic view of a few-mode erbium-doped fiber amplifier (EDFA) forward-pumping according to an aspect of the present disclosure;

FIG. 1(b) shows a schematic view of a few-mode erbium-doped fiber amplifier reverse-pumping according to an aspect of the present disclosure;

FIG. 1(c) shows a schematic view of a few-mode erbium-doped fiber amplifier bi-directional pumping according to an aspect of the present disclosure;

FIG. 2 shows a schematic of an exemplary implementation of a few-mode EDFA according to an aspect of the present disclosure;

FIG. 3 shows a schematic of a few-mode fiber recirculating loop experimental setup showing details for the few-mode erbium-doped fiber amplifier and mechanical loop switch according to an aspect of the present disclosure;

FIG. 4 shows a graph depicting the modal group delay of 25-km FMF of the experimental setup according to an aspect of the present disclosure;

FIG. 5 shows a graph depicting the gain characteristic of FM-EDFA for two pumping configurations of the experimental setup according to an aspect of the present disclosure;

FIG. 6 shows a graph depicting Q vs. launch power after 20×25-km loops of the experimental setup according to an aspect of the present disclosure;

FIG. 7 shows a graph depicting BER vs. transmission distance of the experimental setup according to an aspect of the present disclosure; and

FIG. 8 shows a graph depicting BER vs. OSNR in 0.1 nm. of the experimental setup according to an aspect of the present disclosure;

### DETAILED DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope. More particularly, while numerous specific details are set forth, it is understood that embodiments of the disclosure may be practiced without these specific details and in other instances, well-known circuits, structures and techniques have not be shown in order not to obscure the understanding of this disclosure.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently-known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the invention.

In addition, it will be appreciated by those skilled in art that any flow charts, flow diagrams, state transition diagrams, pseudocode, and the like represent various processes which may be substantially represented in computer readable medium and so executed by a computer or processor, whether or not such computer or processor is explicitly shown.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein. Finally, and unless otherwise explicitly specified herein, the drawings are not drawn to scale.

Thus, for example, it will be appreciated by those skilled in the art that the diagrams herein represent conceptual views of illustrative structures embodying the principles of the disclosure.

By way of some additional background, it is noted that as capacity limitations for single mode fiber transmission are approached, space-division multiplexing (SDM) is one technique showing promise to sustain continued capacity growth. Notably, proposed SDM transmission schemes have include parallel single-mode fibers, multicore fibers, or a combination of each. Each of these proposed schemes exhibit different cost/complexity scalings, and their relative merits are the subject of continued debate. More particularly, multimode fibers have the distinction of achieving the highest capacity per unit area due—in part—to parallel channels collected. It has also been shown that multimode fiber amplifiers exhibit high pump efficiency per bit as compared with parallel single-mode amplifiers. For multimode transmission to be more practical, an amplifier having modal gain control is required. With few-mode fiber (FMF) transmission, higher-order modes typically have higher attenuation and coupling losses, so an amplifier must exhibit an Erbium doping profile or index profile design and pump control in order to preferentially amplify higher order modes.

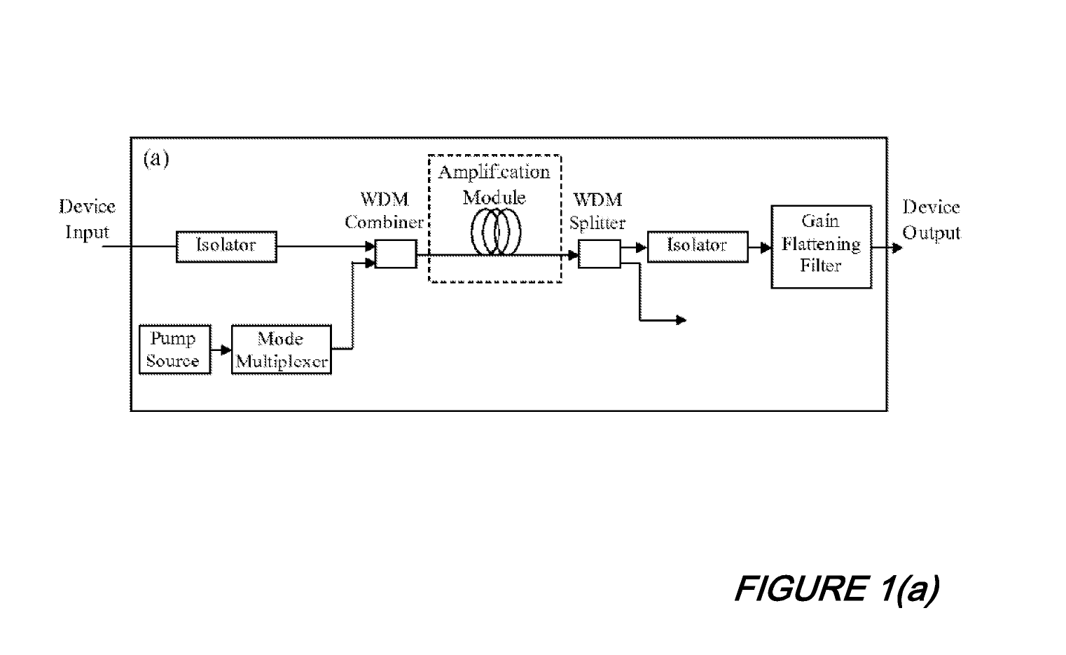

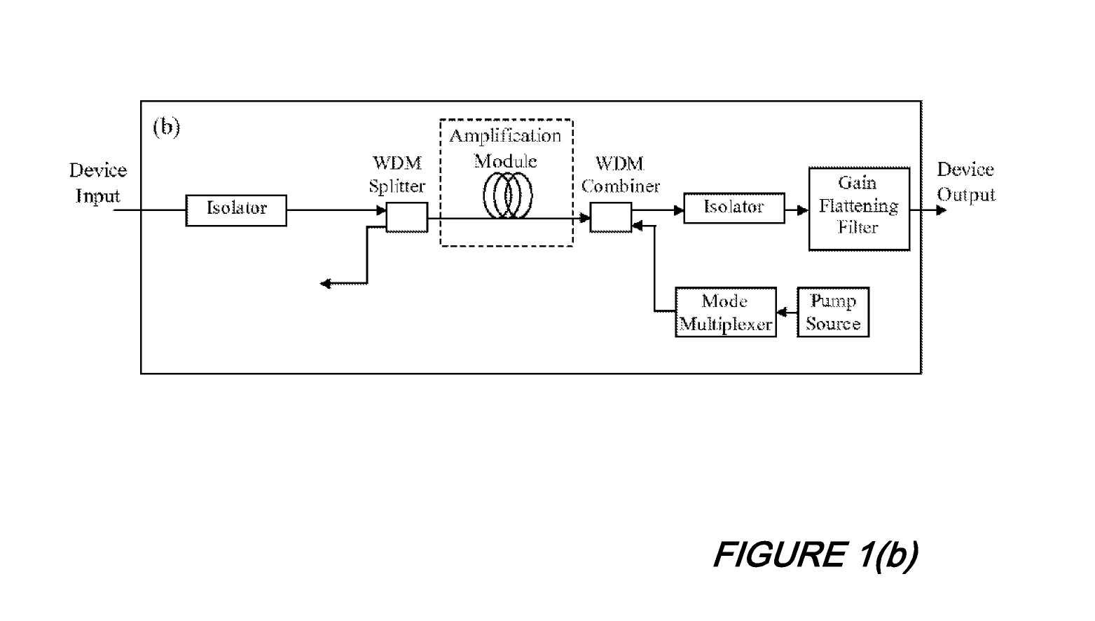

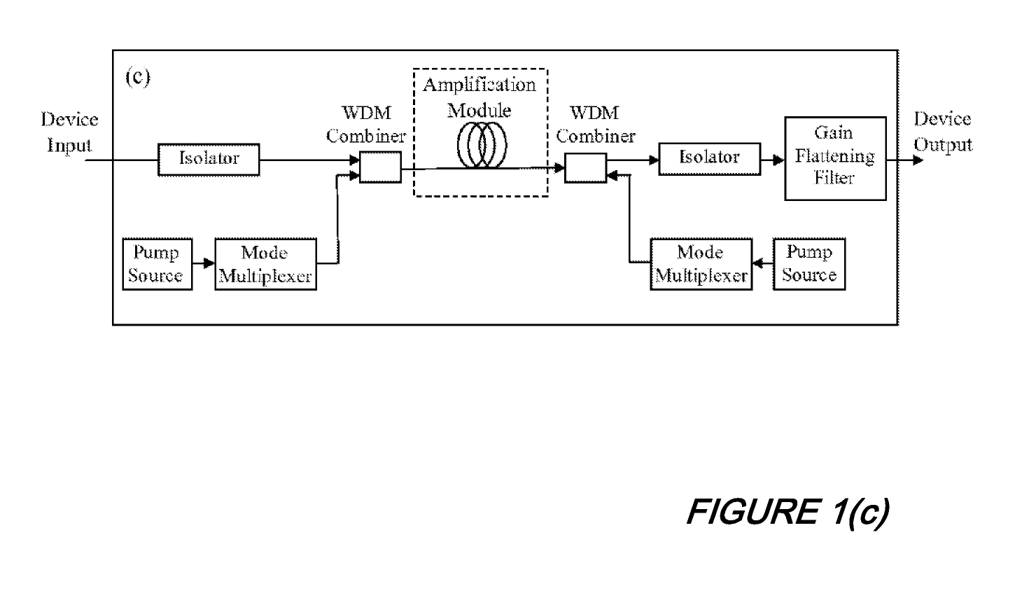

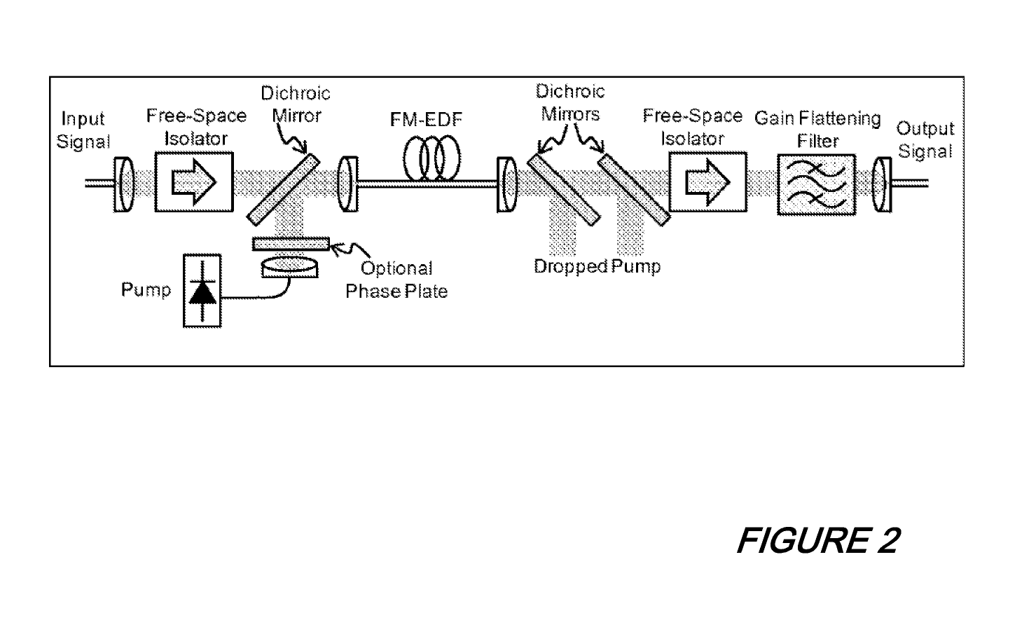

Turning now to FIGS. 1(a), 1(b), and 1(c), there is shown a schematic of a few-mode fiber optical amplifier according to an aspect of the present disclosure exhibiting 1(a) forward-pumping; 1(b) reverse-pumping; and 1(c) bi-directional pumping. FIG. 2 shows an implementation of a few-mode EDFA according to another aspect of the present disclosure. As may be observed from simultaneous reference to these figures, a multimode signal enters the system at the device input via a few-mode fiber (FMF) pigtail which is angle cleaved and terminated in a collimator. The input light enters a polarization insensitive free-space isolator that only enables power flow in the direction indicated by the arrows in the figure. As may be understood, any signal reflected further downstream of the isolator is blocked from “flowing” back through the isolator.

The signal is then combined with a pump signal by a combiner (i.e., dichroic mirror). In the schematic(s) shown, the pump laser is connected to the collimator via a fiber pigtail.

The optical signal may be spatially modulated through the effect of a phase plate (not specifically shown). The combined signal and pump are launched into a few-mode erbium-doped fiber (FM-EDF) via a collimator. At the output of the FM-EDF, which is angle cleaved a both ends, a collimator couples the amplified signal and residual pump signal out to free space. A second polarization insensitive free-space isolator may be used to ensure unidirectional power flow as shown. A series of dichroic mirrors (two shown in figure) are used to drop the residual pump. The amplified signal is then passed through a gain flattening filter before being collimated to an angle-cleaved output few-mode fiber at device output.

In order to suppress spurious lasing, it is necessary to prevent back-reflections from being re-amplified by the FM-EDF. The general steps required to prevent such re-amplification are to angle-cleave all fibers that carry the signal wavelength, and insert the free-space isolators as shown in the figure. It is also necessary to reduce mode-dependent-gain and polarization-dependent gain. Thus, all free space components—including the isolators, the dichroic mirror, gain flattening filter, and other components that should be polarization insensitive.

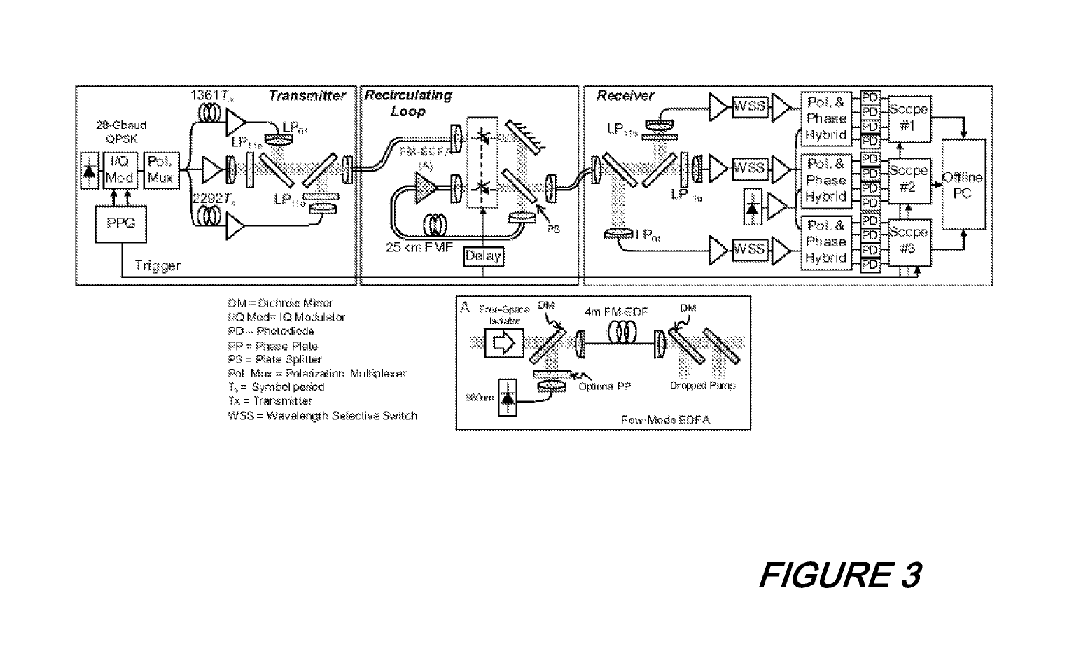

Turning now to FIG. 3, there is shown an experimental setup employing a few-mode erbium doped fiber amplifier according to an aspect of the present disclosure. At the transmitter, a 28 Gbaud DP-QPSK signal is generated in single-mode fiber using a Mach-Zehnder modulator driven with PRBS sequences of duration 2²³-1. The polarization multiplexer splits the signal, delays one component by 405 symbols, rotating it to the orthogonal polarization and recombines the two signal copies.

The polarization-multiplexed signal is then passed through a spatial multiplexer (SMUX) comprising phase plates for spatial modulation and plate splitters for mode combining We ensure that the minimum decorrelation delay between the six mode-polarizations (405 symbols between polarizations) is longer than the memory length of the MIMO equalizer at the receiver to prevent spurious convergence.

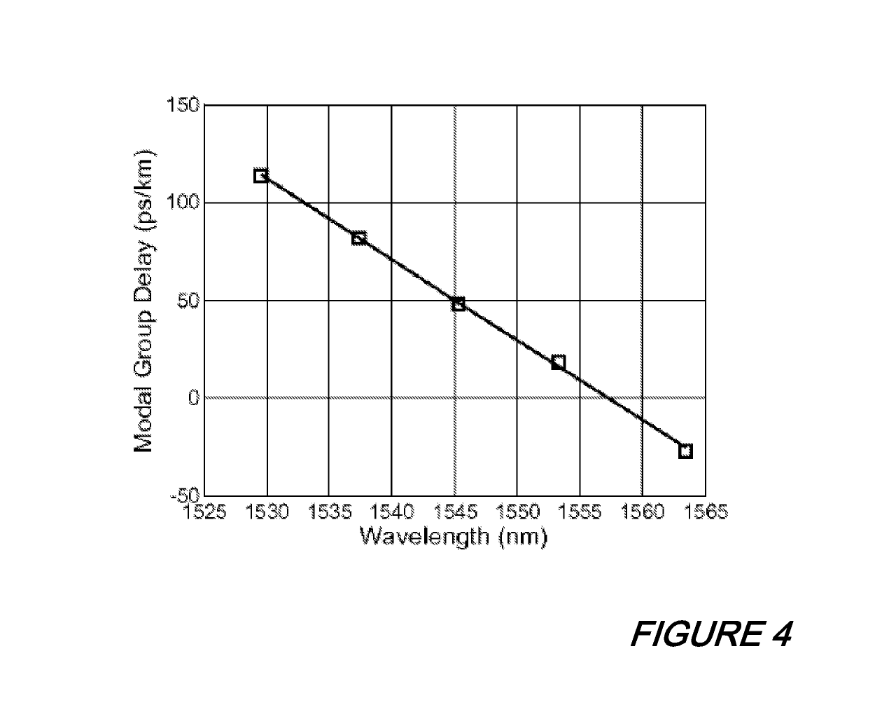

The 6×28-Gbaud mode-multiplexed signal is launched into the few-mode fiber recirculating loop through a pigtail FMF. The recirculating loop comprises a 25-km spool of graded-index few-mode fiber with a modal dispersion characteristic shown graphically in FIG. 4, where a zero-MGD wavelength is observed at 1557.3 nm. We chose this wavelength for our transmission as in the moderate mode-coupling regivme, which minimizes the impulse response duration and enables MIMO detection at the lowest complexity.

The signal is then re-amplified after the 25-km span by a few-mode erbium-doped fiber amplifier (FM-EDFA). Although it has been demonstrated that in theory, a step index profile with a uniform Er-doping in the core pumped in the LP₂₁ mode at 980 nm enables modal gain equalization, in practice, this is difficult to achieve due to (i) difficulty in obtaining high modal purity at a highly multi-moded pump wavelength, (ii) the signal LP₁₁ mode has higher loss per span thus requiring higher gain.

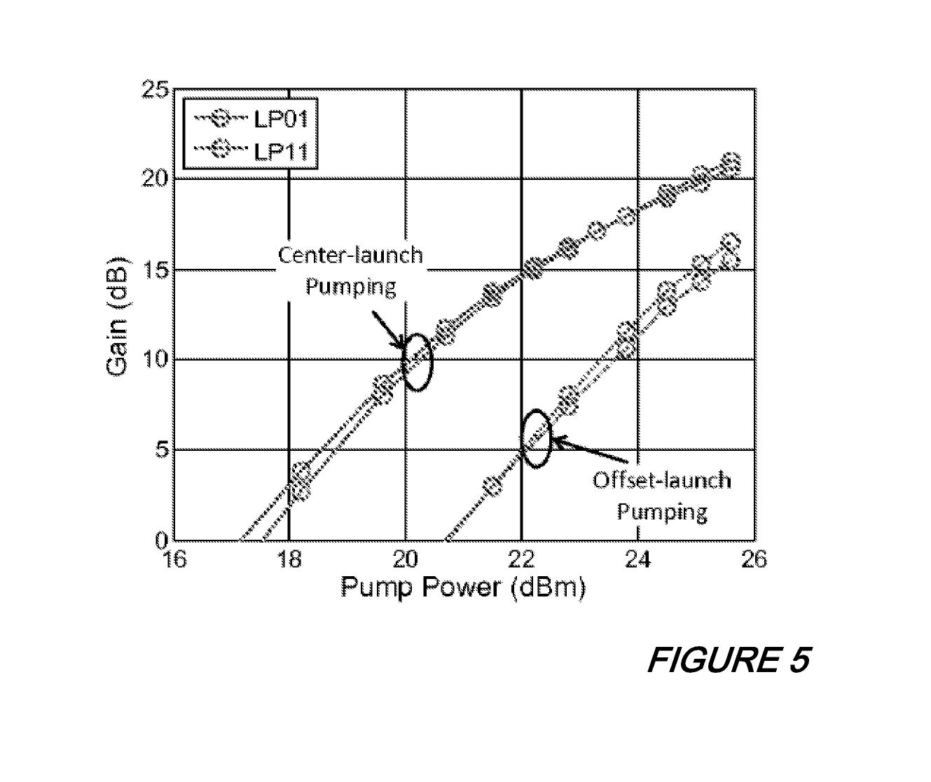

To equalize the modal gain difference per loop, we employed a FM-EDF with ring Er-doping profile inside a step-index profile core. The core delta and core radius are chosen to match the mode field dimensions of the transmission FMF. FIG. 5 shows the gain versus pump power characteristic measured in 4 meters of this fiber when an LP₀₁ and LP₁₁ signal at −5 dBm is applied at its input.

It is observed that in the offset launch position, the LP₁₁ signal has around 1 dB higher gain than the LP₀₁ signal at around 9 or 10 dB gain for each mode, which roughly corresponds to the round-trip losses in our experiment.

Due to the unavailability of acousto-optic loop switches in the few-mode fiber, we used a mechanical free-space loop as shown schematically in FIG. 3. The two beams at the input of the loop switch are the launch beam (from the SMUX) and the loop beam (from the FM-EDFA). The mechanical loop switch enables only one of the beams to pass through at any given time. When the upper beam is allowed to pass through and the lower beam is blocked, signal is loaded into the loop; when the lower beam is allowed to pass, the loop circulates and light is blocked from the transmitter.

A beam splitter is positioned after the loop switch providing the same function as a fiber coupler in a conventional recirculating loop. One of the splitter outputs is directed to the input of the 25-km FMF for circulation, and the other output exits the loop and is directed into the receiver's spatial demultiplexer (SDEMUX).

The losses of the loop components are estimated as follows: (i) FMF 0.2 dB/km in each LP₀₁ and LP₁₁ modes; (ii) plate splitter: ˜2.2 dB for LP₁₁; (iii) coupling loss into FMF: ˜1.5 dB for LP₀₁ and ˜2.2 dB for LP₁₁; (iv) other losses such as dichroic mirrors to add/drop in the 980 nm pump: ˜0.5 dB. The round trip loss is around 9.0 dB for LP₀₁ mode and 9.7 dB for the LP₁₁ mode.

At the receiver, the SDEMUX recovers the LP₀₁ and two LP₁₁ components of the signal in three parallel single-mode fibers. These signals are injected into three synchronized coherent receivers driven by a common local oscillator (LO). In each coherent receiver, the signals and LO are mixed in dual-polarizations optical hybrid followed by photodetectors. The downconverted electrical signals are then sampled and digitized with three LeCroy sampling oscilloscopes at 40 GSa/s and 16 GHz bandwidth.

The phase of the mechanical loop switch and gating of the sampling scope are controlled by a trigger signal derived from the transmitter's pattern generator. By adjusting the delay shown schematically in FIG. 3, we can select the number of loops circulated. We used a 6×6×401 tap MIMO equalizer to recover the QPSK constellations associated with each signal mode-polarizations. We chose a time-domain implementation for the equalizer and adapt its coefficients using a training sequence.

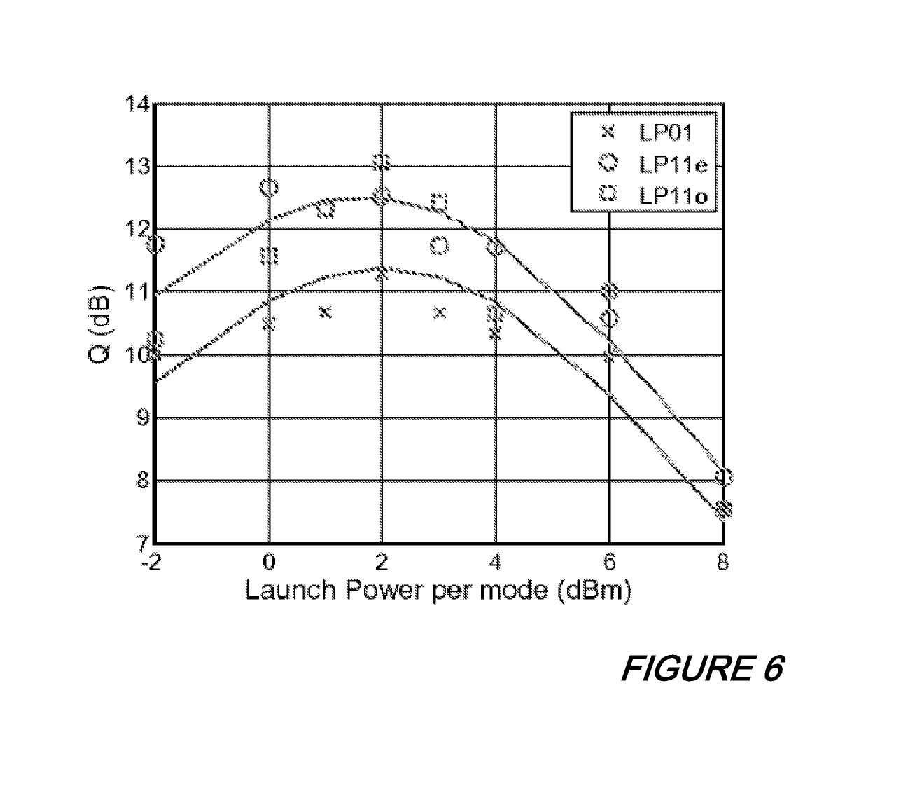

Experimental results are shown graphically in FIGS. 6-8. First, we determined the optimum launch power that minimizes the combined noise of the FM-EDFA and nonlinear effects of the FMF. FIG. 6 shows the Q-factor vs. launch power after 20 loops, with an optimum launch power of around 2dBm per mode (LP₀₁ and each LP₁₁).

With this optimum launch power, we are able to transmit the 6×28 Gbaud QPSK signal through 24×25 km loops until the bit-error rate (BER) of the worst mode falls below the threshold of 3.8×10⁻³ for 7% overhead hard decision forward-error correction (HD-FEC); and 34×25 km if 20% overhead soft-decision FEC (SD-FEC) is used with BER threshold of 2×10⁻².

Mode-dependent loss (MDL) ultimately limited the system reach. The sources of MDL in this experiment include: (i) the FM-EDFA where despite best effort, the round-trip loss of the LP₁₁ mode is around 0.15 dB lower than LP₀₁, (ii) non-ideal coupling from free-space into fiber may cause mode-polarizations to have slightly different losses; (iii) polarization-dependent loss (PDL) of loop elements such as splitters, isolators and dichroic mirrors, although we estimate PDL to be <0.1 dB per element.

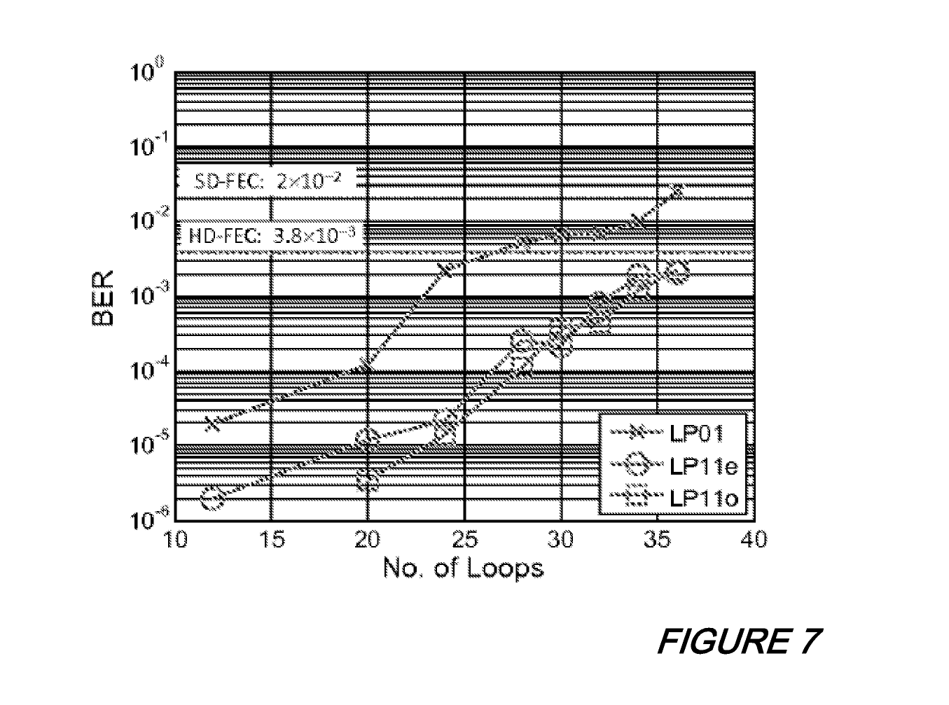

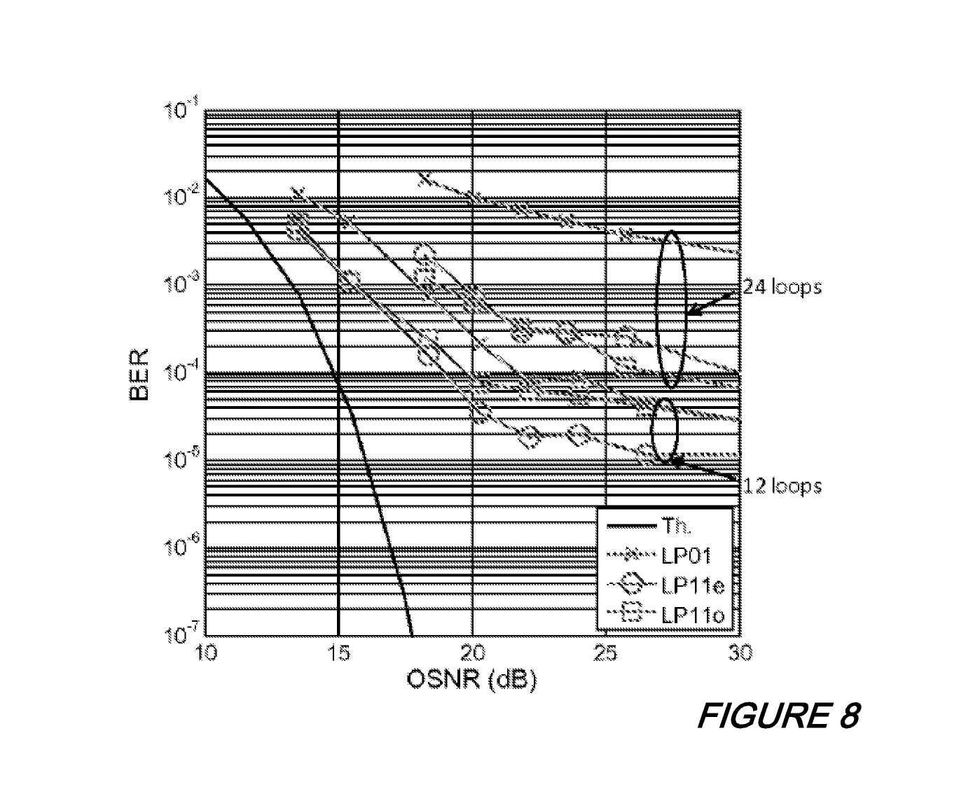

FIG. 7 shows BER versus distance for this experiment. Finally, we measured BER versus OSNR and the results are shown in FIG. 8 after 12 and 24 loops.

Those skilled in the art will readily appreciate that while the methods, techniques and structures according to the present disclosure have been described with respect to particular implementations and/or embodiments, those skilled in the art will recognize that the disclosure is not so limited. Accordingly, the scope of the disclosure should only be limited by the claims appended hereto.

1. A multi-mode fiber amplifier with tunable modal gain comprising:
an amplifying medium operable to support the propagation of multiple modes at a signal wavelength;
a pump laser connected to a mode multiplexer;
wavelength division multiplexed (WDM) combiners for multiplexing or demultiplexing the signal with the pump;
a gain flattening filter for equalizing the amplifiers gain versus wavelength characteristic; and
isolators for preventing back-reflections such that spurious lasing is prevented.

2. The multi-mode fiber amplifier of claim 1 wherein the amplifying medium comprises a few-mode fiber exhibiting a refractive index profile such that the propagation of multiple signal modes is effected, and having a dopant concentration such that mode-dependent gain is controlled.

3. The multi-mode fiber amplifier of claim 2 wherein the pump laser operates at any wavelength corresponding to an absorption wavelength of the dopant species employed in the amplifying medium.

4. The multi-mode fiber amplifier of claim 3 wherein the dopant species is Er³⁺ and the wavelength is one selected from the group consisting of 980 nm and 1480 nm.

5. The multi-mode fiber amplifier of claim 4 wherein the isolators are free-space isolators.

6. The multi-mode fiber amplifier of claim 5 wherein the gain flattening filter is a grating or spatial hologram having a transmittance characteristic such that the overall device exhibits a flat gain profile over a usable signal band.

7. The multi-mode fiber amplifier of claim 6 wherein gain flattening filter is a grating based upon a multimode fiber supporting at least as many modes as that exhibited by an input signal.

8. The multi-mode fiber amplifier of claim 6 wherein the gain flattening filter is a fiber-based grating and the device includes additional collimators to couple a signal into and out of the grating from free space.

9. A multi-mode fiber amplifier comprising:
a free space isolator which receives an input signal an outputs an isolated signal;
a dichroic mirror which receives the isolated signal and a pump signal output from a pump source;
the pump source that outputs the pump signal that is directed to the dichroic mirror;
a few-mode erbium doped fiber that receives the isolated signal and the pump signal directed via the dichroic mirror and outputs an amplified signal;
a pair of dichroic mirrors that receive the amplified signal such that the pump signal is dropped from the amplified signal;
a second free space isolator that receives the amplified signal having the pump signal dropped and outputs an isolated amplified signal;
a gain flattening filter that receives the isolated amplified signal and outputs a flattened, output signal;
